(19) United States
(12) Patent Application Publication
(10) Pub. No.: US 2007/0256019 A1
(43) Pub. Date: Nov. 1, 2007

(54) Display Sharing Preference System

(76) Inventors: Praveen Prasanna Kumar Hirsave, Austin, TX (US); Minto Tsai, Austin, TX (US); Neil Allen Taylor, Cedar Park, TX (US)

Correspondence Address: IBM CORP (YA);C/O YEE & ASSOCIATES PC, P.O. BOX 802333, DALLAS, TX, 75380, US

(21) Appl. No.: 11/279,766

(22) Filed: Apr. 14, 2006

(51) Int. Cl. G06F 3/00

(52) U.S. Cl. 715/741

(57) ABSTRACT

Computer implemented method, system and computer program product for controlling a secondary display of an application relative to a primary display of the application. A computer implemented method for controlling a secondary display of an application relative to a primary display of the application includes displaying the application on the primary display. A display policy for the application is determined, and the application is displayed on the secondary display in accordance with the determined display policy.

### BACKGROUND OF THE INVENTION

1. Field of the Invention

The present invention relates generally to the data processing field, and more particularly, to a computer implemented method, system and computer program product for controlling a secondary display of an application relative to a primary display of the application.

2. Description of the Related Art

Frequently, it is desirable to transfer an application that is displayed on a primary display, for example, a laptop computer screen, to a secondary display, for example, a large screen of a projection system. Projecting the application onto a large screen enables a group of people to view the application simultaneously, and can be very useful in the classroom, during a conference and in many other environments.

Conventionally, the projected, secondary display presents the same image as the primary display. It may be desirable, however, that the image presented on the secondary display contains less information than the image on the primary display. For example, the image on the primary display may include confidential or other sensitive data that should not be disclosed to a general audience. Also, a presenter may wish the image on the secondary display to contain less information than the image on the primary display in order to emphasize a particular aspect of the overall image. For example, an image on the primary display may contain both graphic and text material, and the presenter may wish to present an image of only the graphic material on the secondary display in order to emphasize the graphic material.

It would, accordingly, be desirable to provide a mechanism for controlling a secondary display of an application relative to a primary display of the application in order to control what is actually presented on the secondary display.

### SUMMARY OF THE INVENTION

Exemplary embodiments provide a computer implemented method, system and computer program product for controlling a secondary display of an application relative to a primary display of the application. A computer implemented method for controlling a secondary display of an application relative to a primary display of the application includes displaying the application on the primary display. A display policy for the application is determined, and the application is displayed on the secondary display in accordance with the determined display policy.

### BRIEF DESCRIPTION OF THE DRAWINGS

The novel features believed characteristic of exemplary embodiments are set forth in the appended claims. A preferred mode of use and further objectives and advantages will best be understood by reference to the following detailed description of an illustrative embodiment when read in conjunction with the accompanying drawings, wherein:

FIG. 1 depicts a pictorial representation of a network of data processing systems in which aspects of exemplary embodiments may be implemented;

FIG. 2 is a block diagram of a data processing system in which aspects of exemplary embodiments may be implemented;

FIG. 3 is a block diagram that schematically illustrates a hardware-based display-sharing system according to an exemplary embodiment;

FIG. 4 is a block diagram that schematically illustrates a software-based display-sharing system according to an exemplary embodiment; and

FIG. 5 is a flowchart that illustrates a method for controlling a secondary display of an application relative to a primary display of the application according to an exemplary embodiment.

### DETAILED DESCRIPTION OF THE PREFERRED EMBODIMENT

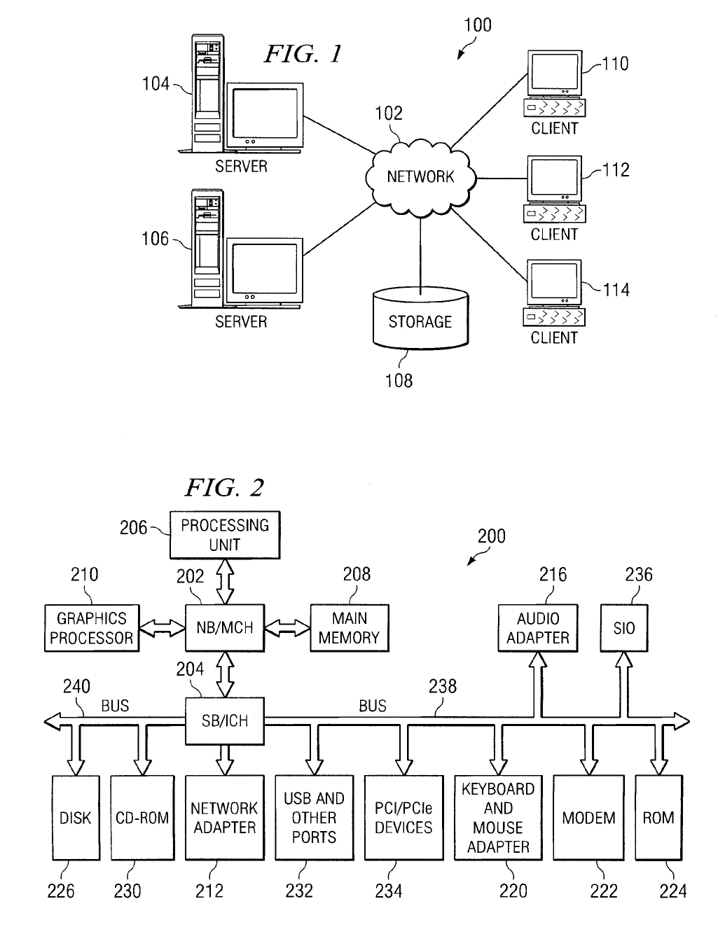

With reference now to the figures and in particular with reference to FIGS. 1-2, exemplary diagrams of data processing environments are provided in which exemplary embodiments may be implemented. It should be appreciated that FIGS. 1-2 are only exemplary and are not intended to assert or imply any limitation with regard to the environments in which aspects or embodiments may be implemented. Many modifications to the depicted environments may be made without departing from the spirit and scope of the exemplary embodiments.

With reference now to the figures, FIG. 1 depicts a pictorial representation of a network of data processing systems in which aspects of exemplary embodiments may be implemented. Network data processing system 100 is a network of computers in which exemplary embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different exemplary embodiments.

With reference now to FIG. 2, a block diagram of a data processing system is shown in which aspects of exemplary embodiments may be implemented. Data processing system 200 is an example of a computer, such as server 104 or client 110 in FIG. 1, in which computer usable code or instructions implementing the processes for embodiments may be located.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206 and coordinates and provides control of various components within data processing system 200 in FIG. 2. As a client, the operating system may be a commercially available operating system such as Microsoft® Windows® XP (Microsoft and Windows are trademarks of Microsoft Corporation in the United States, other countries, or both). An object-oriented programming system, such as the Java™ programming system, may run in conjunction with the operating system and provides calls to the operating system from Java™ programs or applications executing on data processing system 200 (Java is a trademark of Sun Microsystems, Inc. in the United States, other countries, or both).

As a server, data processing system 200 may be, for example, an IBM® eServer™ pSeries® computer system, running the Advanced Interactive Executive (AIX®) operating system or the LINUX® operating system (eServer, pSeries and AIX are trademarks of International Business Machines Corporation in the United States, other countries, or both while LINUX is a trademark of Linus Torvalds in the United States, other countries, or both). Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for exemplary embodiments are performed by processing unit 206 using computer usable program code, which may be located in a memory such as, for example, main memory 208, ROM 224, or in one or more peripheral devices 226 and 230.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of exemplary embodiments may be applied to a multiprocessor data processing system.

In some illustrative examples, data processing system 200 may be a personal digital assistant (PDA), which is configured with flash memory to provide non-volatile memory for storing operating system files and/or user-generated data.

A bus system may be comprised of one or more buses, such as bus 238 or bus 240 as shown in FIG. 2. Of course, the bus system may be implemented using any type of communication fabric or architecture that provides for a transfer of data between different components or devices attached to the fabric or architecture. A communication unit may include one or more devices used to transmit and receive data, such as modem 222 or network adapter 212 of FIG. 2. A memory may be, for example, main memory 208, ROM 224, or a cache such as found in NB/MCH 202 in FIG. 2. The depicted examples in FIGS. 1-2 and above-described examples are not meant to imply architectural limitations. For example, data processing system 200 also may be a tablet computer, laptop computer, or telephone device in addition to taking the form of a PDA.

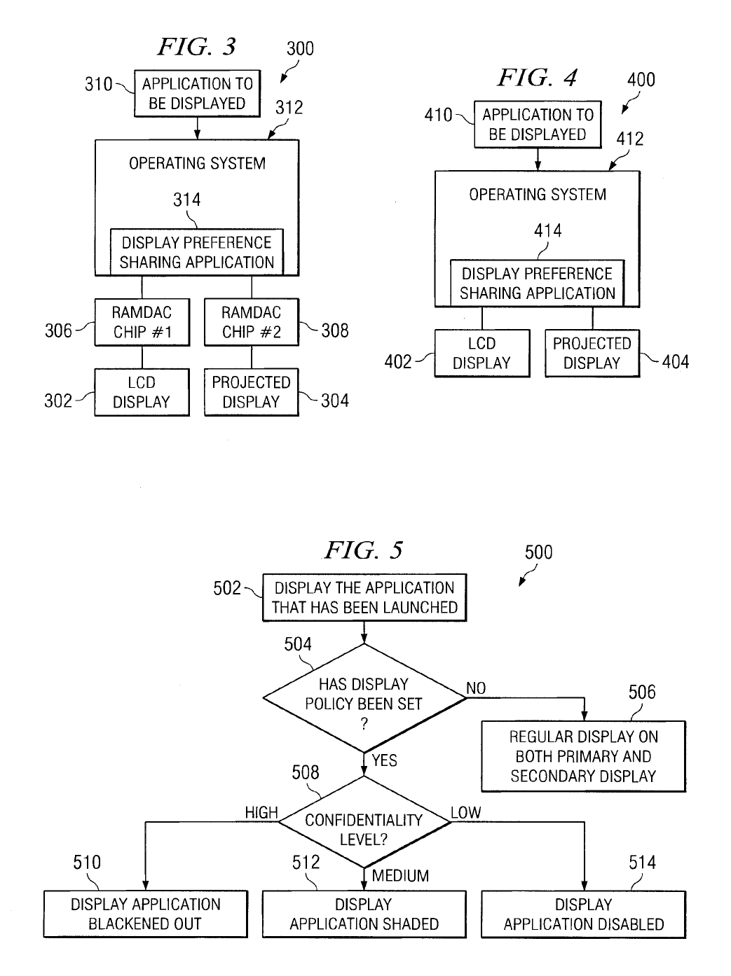

Exemplary embodiments provide a computer implemented method, system and computer program product for controlling a secondary display of an application relative to a primary display of the application in order to control what is actually presented on the secondary display. FIG. 3 is a block diagram that schematically illustrates a hardware-based display-sharing system according to an exemplary embodiment. The system is generally designated by reference number 300, and includes primary display 302, for example, an LCD display on a laptop computer, and secondary display 304, for example, a projected display of a projection system.

System 300 also includes first and second RAMDAC (Random Access Memory Digital-to-Analog Converter) chips 306 and 308. First RAMDAC chip 306 enables primary display 302, and second RAMDAC chip 308 enables secondary display 304. In particular, RAMDAC chips 306 and 308 are image signal converter devices that receive a digitally encoded image signal from application 310 to be displayed, and convert the received digital image signal to an analog image signal that can be displayed on displays 302 and 304, respectively.

System 300 additionally includes display control application 314, also referred to herein as a “Display Preference Sharing Application” that runs on operating system layer 312 to control second RAMDAC chip 308 that enables secondary display 304 so as to control the image that is actually presented on secondary display 304. Operating system layer 312 can, for example, run on processing unit 206 of data processing system 200 illustrated in FIG. 2.

Display Preference Sharing Application 314, in effect, takes ownership of second RAMDAC chip 308 and mirrors the application on primary display 302 from first RAMDAC chip 306. Display Preference Sharing Application 314 also sets policies specifying the extent to which information displayed on primary display 302 is also displayed on secondary display 304.

In particular, according to exemplary embodiments, the mirrored application can be displayed on secondary display 304 in various forms including, for example, in a blackened out, shaded (partially blackened out), disabled or off form, depending on user preference. The behavior of Display Preference Sharing Application 314 in displaying the application on the second display in one of these manners is determined by a user setting a display policy for each application to be displayed. For example, the display policy can specify a confidentiality level for the application as being high, medium or low. When the user determines that the confidentiality level of an application being displayed on primary display 302 is high, Display Preference Sharing Application 314 controls RAMDAC 308 to display application 310 on secondary display 304 in a blackened out condition so that no information is displayed to viewers of the secondary display or in an off condition such that an audience viewing the secondary display will not even recognize that there is a display on the primary display. Alternatively, when the confidentiality level of the application is medium, Display Preference Sharing Application 314 controls RAMDAC 308 to display only a portion or portions of the application that is displayed on primary display 302. For example, Display Preference Sharing Application may control RAMDAC 308 such that only graphic material presented on the primary display is displayed on secondary display 304 while text material appearing on the primary display is not presented on the secondary display.

If the confidentiality level of application 310 to be displayed is low, Display Preference Sharing Application controls second RAMDAC 308 so that the application will appear on secondary display 304 disabled so as to prevent actions from being taken with respect to what is displayed on secondary display 304. Disabling secondary display 304 can include, for example, disablement of a portion of the application or disablement of the entire application. Such disablement will not impact others applications that are currently displayed on the secondary screen, and the user can enable a portion, or all of a partially or fully disabled application when desired.

Thus, Display Preference Sharing application 314 provides a mechanism by which a secondary display of an application can be controlled relative to a primary display of the application in order to control what is actually presented on the secondary display. Although, according to an exemplary embodiment described herein, Display Preference Sharing Application 314 controls the secondary display to be blackened out (or off), partially blackened out or disabled depending on whether the confidentiality level is set as high, medium or low, this is intended to be exemplary only as Display Preference Sharing Application 314 can also be designed to control the secondary display in other ways depending on any number of settings based on a level of confidentiality or on another basis. For example, in another exemplary embodiment, Display Preference Sharing Application 314 can be used to highlight certain portions of the secondary display, such as by making it brighter, based on a particular setting specified by the user.

FIG. 4 is a block diagram that schematically illustrates a software-based display-sharing system according to an exemplary embodiment. The system is generally designated by reference number 400, and, similar to system 300 illustrated in FIG. 3, includes primary display 402 and secondary display 404. System 400 differs from system 300; however, in that Display Preference Sharing Application 414 running on OS layer 412 takes ownership of secondary display 404 directly rather than indirectly through a RAMDAC. In a similar manner as described above with respect to system 300 illustrated in FIG. 3, Display Preference Sharing Application 414 displays on secondary display 404, taking into account the display policy for application 410 to be displayed, the application widgets as being disabled, shaded (partially blackened out) or blackened out (or off).

FIG. 5 is a flowchart that illustrates a method for controlling a secondary display of an application relative to a primary display of the application according to an exemplary embodiment. The method is generally designated by reference number 500, and begins by displaying an application that has been launched on a primary display (Step 502). A determination is made whether a display policy has been set for the application (Step 504). If a display policy has not been set for the application (No output of Step 504), the application is displayed on a secondary display in the same form as on the primary display (Step 506).

If a display policy has been set for the application (Yes output of Step 504), a determination is made of the confidentiality level of the setting (Step 508). If the confidentiality setting is “high” (High output of Step 508), the application is displayed on the secondary display in a fully blackened out (or off) form (Step 510). If the confidentiality setting is “medium” (Medium output of Step 508), the application is displayed on the secondary display in a shaded form in which only a portion or portions of the application is displayed on the secondary display (Step 512). If the confidentiality setting is “low” (Low output of Step 508), the application is displayed on the secondary display in a disabled form (Step 514). The user may enable the disabled display to fully display the application on the secondary display should he desire to do so.

Exemplary embodiments thus provide a computer implemented method, system and computer program product for controlling a secondary display of an application relative to a primary display of the application. A computer implemented method for displaying an application in a different manner on different displays includes displaying the application on a primary display. A display policy for the application is determined, and the application is displayed on a secondary display in accordance with the determined display policy.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for controlling a secondary display of an application relative to a primary display of the application, comprising:
displaying an application that has been launched on a primary display;
determining a display policy for the application; and
displaying the application on a secondary display in accordance with the determined display policy.

2. The computer implemented method according to claim 1, wherein displaying an application on a secondary display in accordance with the determined display policy, comprises:
displaying the application on a projected display in accordance with the determined display policy.

3. The computer implemented method according to claim 1, wherein determining a display policy for the application, comprises:
determining a confidentiality level for the application among a plurality of confidentiality levels.

4. The computer implemented method according to claim 3, wherein determining a confidentiality level of the application among a plurality of confidentiality levels, comprises determining a confidentiality level of the application among high, medium and low confidentiality levels.

5. The computer implemented method according to claim 1, wherein displaying the application on a secondary display in accordance with the determined display policy, comprises:
displaying the application on a secondary display in one of a blackened out, a partially blackened out and a disabled display.

6. The computer implemented method according to claim 5, and further comprising:
enabling the disabled display to display at least a portion of the application on the secondary display.

7. The computer implemented method according to claim 1, and further comprising:
determining whether the application to be displayed has a display policy; and
displaying the application on the secondary display in the same manner as on the primary display if it is determined that the application to be displayed does not have a display policy.

8. The computer implemented method according to claim 1, wherein a user specifies the display policy for the application.

9. A system for controlling a secondary display of an application relative to a primary display of the application comprising:
a primary display for displaying an application to be displayed;
a secondary display for displaying the application to be displayed; and
a display control mechanism for displaying the application to be displayed on the secondary display in accordance with a determined display policy.

10. The system according to claim 9, wherein the determined display policy comprises one of a plurality of confidentiality levels.

11. The system according to claim 10, wherein the plurality of confidentiality levels comprises high, medium and low confidentiality levels.

12. The system according to claim 9, wherein the application to be displayed is displayed on the secondary display is one of a blackened out, a partially blackened out and a disabled display.

13. The system according to claim 9, wherein the display policy is specified by a user of the application to be displayed.

14. The system according to claim 9, wherein the display control mechanism comprises a display control application.

15. The system according to claim 14, and further comprising a digital-to-analog signal converter for the secondary display, wherein the display control application takes control of the digital-to-analog signal converter for displaying the application to be displayed on the secondary display in accordance with the determined display policy.

16. The system according to claim 15, wherein the digital-to-analog signal converter comprises a RAMDAC chip.

17. The system according to claim 9, wherein the secondary display comprises a display of a projection system.

18. A computer program product, comprising:
a computer usable medium having computer usable program code configured for controlling a secondary display of an application relative to a primary display of the application, the computer program product comprising:
computer usable program code configured for displaying an application that has been launched on a primary display;
computer usable program code configured for determining a display policy for the application; and
computer usable program code configured for displaying the application on a secondary display in accordance with the determined display policy.

19. The computer program product according to claim 18, wherein the computer usable program code configured for determining a display policy for the application, comprises:
computer usable program code configured for determining a confidentiality level for the application among a plurality of confidentiality levels.

20. The computer program product according to claim 18, wherein the computer usable program code configured for displaying the application on a secondary display in accordance with the determined display policy, comprises:
computer usable program code configured for displaying the application on a secondary display in one of a blackened out, a partially blackened out and a disabled display.
